(19) United States
(12) Patent Application Publication
(10) Pub. No.: US 2008/0001850 A1
(43) Pub. Date: Jan. 3, 2008

(54) Beam scanner with reduced phase error

(76) Inventors: Mark Champion, Kenmore, WA (US); Steven L. Holmes, Sammamish, WA (US)

Correspondence Address: GRAYBEAL, JACKSON, HALEY LLP, 155 - 108TH AVENUE NE, SUITE 350, BELLEVUE, WA, 98004-5973, US

(21) Appl. No.: 11/810,960

(22) Filed: Jun. 6, 2007

Related U.S. Application Data
(60) Provisional application No. 60/811,495, filed on Jun. 6, 2006.

(51) Int. Cl. G02B 26/10; G09G 5/00

(52) U.S. Cl. 345/7; 359/198

(57) ABSTRACT

According to embodiments, a beam scanning system such as a scanned beam display or scanned beam image capture system includes a controller having a PLL circuit that is operable to track systematic variations in fast scan frequency, such as those that are a function of slow scan angle. The controller is further operable to modify video clocking to compensate for the systematic variations in fast scan phase as a function of slow scan angle.

### CROSS REFERENCE TO RELATED APPLICATIONS

This patent application claims priority benefit from and incorporates by reference U.S. Provisional Patent Application Ser. No. 60/811,495, entitled BEAM SCANNER WITH REDUCED PHASE ERROR, invented by Mark Champion et al., filed Jun. 6, 2006.

### TECHNICAL FIELD

The present disclosure relates to methods and apparatuses for scanning beams of light, and especially to methods and apparatuses for scanning beams of light with a scanner subject to variations in scan frequency to produce pixels having reduced phase error.

### BACKGROUND

Scanned beams of light are used for a variety of applications including image display and image capture. Biaxial MEMS scanners may be used to scan a beam across a two-dimensional (2D) field-of-view (FOV). For high video rate applications particularly, it may be advantageous to run a fast scan axis resonantly.

Because of the physical parameters of a MEMS scanner, beam scanning velocity may vary. One approach to accommodating variations in a scanning velocity has been to generate a video clock that is synchronized to the average scanning velocity of the MEMS scanner.

### OVERVIEW

According to an illustrative embodiment, a beam of light is scanned in two dimensions with a bi-axial MEMS scanner. At least a fast scan axis may be driven to scan resonantly. The instantaneous resonant scanning frequency of the MEMS device may be susceptible to systematic variation as a function of slow scan position and also as a function of random jitter. A scanner phase, velocity, or position detector may be used to measure the behavior of the MEMS scanner. A phase-locked-loop (PLL) is functionally coupled to the detector and is operable to track the scanner frequency, for example as changes in phase. The pass band of the PLL is selected to allow relatively close tracking of the systematic variation within a video frame and to filter out higher frequency random jitter. The PLL output provides a signal for generating a compensated video clock for clocking pixels, for example to modulate emitter power in a scanned beam display or to clock values from a detector in a scanned beam imager. The compensated video clock modifies the timing of the pixels to correspond to the actual position of the scanned beam.

### BRIEF DESCRIPTION OF THE DRAWINGS

FIG. 1 is a block diagram of an electronic device with a scanned beam display, according to an embodiment.

FIG. 2 is a perspective view of an integrated optical engine portion of a scanned beam display, according to an embodiment.

FIG. 3 is a block diagram of a scanned beam imager, according to an embodiment.

FIG. 4 is a perspective view of the micro-machined portion of an illustrative biaxial MEMS scanner, according to an embodiment.

FIG. 5 illustrates a simplified scan path traversing a display area in a field-of-view, according to an embodiment.

FIG. 6 is a block diagram for a scanned beam display controller, according to an embodiment.

FIG. 7 is a block diagram that includes a scanner control module according to an embodiment.

FIG. 8 is a plot showing variability of the fast scan frequency of a MEMS biaxial scanner as a function of time according to an embodiment.

FIG. 9 is a simplified diagram illustrating pixel placement error from a beam scanned by a scanner having the variability in fast scan frequency illustrated in the waveform of FIG. 8, according to an embodiment.

FIG. 10 is a simplified block diagram of a compensated video clock generation circuit made according to an embodiment.

FIG. 11 is a data plot showing filtered output of the VCO of FIG. 10 illustrating especially suppression of jitter, according to an embodiment.

FIG. 12 is a diagram of a PLL controller chip showing the relationship between functional portions, according to an embodiment.

FIG. 13 is a diagram of a filter and charge pump for use with the controller chip of FIG. 12, according to an embodiment.

FIG. 14 is a plot showing reduced phase error between the compensated video clock and the scanned beam position, according to an embodiment.

### DETAILED DESCRIPTION

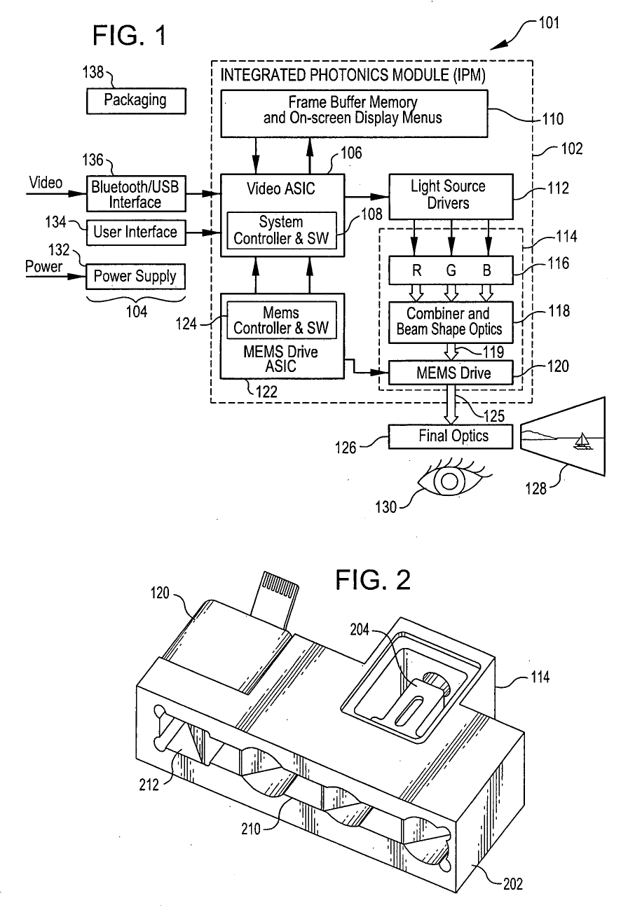

FIG. 1 is a block diagram of an electronic device 101 including an integrated photonics module 102 for displaying images such as video images according to an embodiment. According to the illustrative embodiment, the integrated photonics module 102 may include interfaces to system resources 104. Video controller electronics 106, which may be embodied as an integrated video application-specific integrated circuit (ASIC) including a system controller and software 108, receives an input video signal. The video controller electronics 106 may at least temporarily buffer received video images in video memory 110, which may include frame buffer memory and on-screen display menus. When it is time to display a new video frame, the video controller electronics 106 reads the cached video frame from the video memory 110 and sequentially drives one or more light source drivers 112 to a sequence of brightness values corresponding to pixel values in the input video signal. The light source drivers 112 drive one or more light sources 116, which may be included in an integrated optical engine portion 114 of the integrated photonics module 102, according to an embodiment. The light sources 116 create one or more modulated beams of light that may be shaped and combined by the combiner and-beam shaping optics 118 into a modulated composite beam of light 119. The light sources 116 may, for example, comprise red, green, and blue modulated lasers. According to some embodiments, the modulated composite beam of light 119 may be directed toward a scanner 120, which may for example be a MEMS scanner, operable to scan the modulated composite beam over a field of view (FOV) to create an image.

While the video controller electronics 106 drives the light source drivers 112, it simultaneously drives a scanner controller 122, which may optionally be embodied as a scanner drive ASIC that may, according to some embodiments, also contain a scanner controller and software 124. The scanner controller 122 is operable to drive the scanner 120 to sequentially scan the emitted light across the FOV as a modulated scanned beam of light 125 in a periodic scan pattern.

The scanner 120 deflects the modulated beam of light across the FOV to produce a scanned beam of light 125. The scanned beam of light 125 may optionally be conditioned and/or relayed by final optics 126 to produce a video image 128.

Taken together, the light sources 116, the combiner and beam shaping optics 118, and the scanner 120, along with mechanical mounting structures, actuators, etc., may comprise an integrated optical engine 112; which may in turn comprise an integrated photonics module. Instantaneous positions of the scanned beam of light 125 sequentially illuminate spots in the FOV, the FOV comprising a display surface, exit pupil expander (EPE), or projection screen. To display an image, substantially all the spots in the FOV are sequentially illuminated, nominally with an amount of power proportional to the brightness of an input video image pixel corresponding to each spot.

While the beam illuminates the spots, a portion of the illuminating light beam is reflected or scattered as scattered energy. A portion of the scattered light energy may travel to one or more viewers 130. Persistence of vision in the viewer's eye and mind integrates the sequence of illuminated spots in the FOV into a recognizable video image 128 that may comprise static and/or moving images.

According to some embodiments, light detectors (not shown) may also be aligned to receive a portion of the scattered light energy from the FOV. A variety of processing may be applied to the received scattered light energy to provide functionality. Some embodiments of the functionality of detectors that may be included as a portion of an integrated photonics module. Such detectors may be aligned to receive de-scanned energy off the scanner via a retro-collective or confocal arrangement, or may be aligned to receive light directly or through relay optics from the FOV via a staring detection arrangement.

The light sources 116 may include multiple emitters such as, for instance, light emitting diodes (LEDs), lasers, thermal sources, arc sources, fluorescent sources, gas discharge sources, or other types of emitters. According to one embodiment,,a light source 116 comprises a red laser diode having a wavelength of approximately 635 to 670 nanometers (nm). According to another embodiment, the light sources 116 comprises three lasers including a red diode laser operable to emit a beam at approximately 635 nm; a green diode-pumped solid state (DPSS) laser such as frequency-doubling or second harmonic generation (SHG) laser excited by an infrared laser diode at about 1064 nm wavelength, the green SHG laser being operable to emit a green beam of light at about 532 nm; and a blue laser diode operable to emit light at about 473 nm. While some lasers may be directly modulated, other lasers may require external modulation such as an acousto-optic modulator (AOM) for instance. In the case where an external modulator is used, it is considered part of the light source 116. Laser diode light sources are illustrated as part of integrated photonics module embodiments shown below.

The beam combining and shaping optics 118 are aligned to receive the beams of light emitted by the light sources and to combine some or all of the beams into a single beam. The beam combining and shaping optics 118 may also include beam-shaping optics such as one or more circularizing lenses, collimating lenses, focusing lenses, relay lenses, and/or apertures and wavelength selecting optics such as birefringent filters, gel filter, hot mirrors, etc. Additionally, while the wavelengths described have been in the optically visible range, other wavelengths may be within the scope of the invention.

According to various embodiments, the scanner 120 may be formed as a MEMS scanner. A MEMS scanner may be of a type described in U.S. patent application Ser. No. 10/984327, entitled MEMS DEVICE HAVING SIMPLIFIED DRIVE, for example, incorporated herein by reference.

In the case of a 2D scanner, scanner 120 is driven to scan output beam 125 along a plurality of axes (optionally through final optics 126) to sequentially illuminate pixels in the field of view to produce the image 128.

For compact and/or portable display systems 101, a MEMS scanner is often preferred, owing to the high frequency, durability, repeatability, and/or energy efficiency of such devices. A bulk micro-machined or surface micro-machined silicon MEMS scanner may be preferred for some applications depending upon the particular performance, environment or configuration. One exemplary MEMS scanner embodiment is presented in perspective in FIG. 4. Other embodiments may be preferred for other applications.

A 2D MEMS scanner embodiment of the scanner 120 scans one or more light beams 125 at high speed in a pattern that covers an entire projection screen or a selected region of a projection screen within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern to create a progressive scan pattern. A progressively scanned bi-directional approach with a single beam, scanning horizontally at scan frequency of approximately 19 KHz and scanning vertically in sawtooth pattern at 60 Hz can approximate an SVGA resolution. In one such system, the horizontal scan motion is driven electrostatically and the vertical scan motion is driven magnetically. Alternatively, both the horizontal scan may be driven magnetically or capacitively. Electrostatic driving may include electrostatic plates, comb drives or similar approaches. In various embodiments, both axes may be driven sinusoidally or resonantly.

The integrated photonics module 102 may be embodied as monochrome, as full-color, or hyper-spectral. In some embodiments, it may also be desirable to add color channels between the conventional RGB channels used for many color displays. Herein, the term grayscale and related discussion shall be understood to refer to each of these embodiments as well as other methods or applications within the scope of the invention. In the control apparatus and methods described below, pixel gray levels may comprise a single value in the case of a monochrome system, or may comprise an RGB triad or greater in the case of color or hyperspectral systems. Control may be applied individually to the output power of particular channels (for instance red, green, and blue channels) or may be applied universally to all channels, for instance as luminance modulation.

The system resources 104 may include a power supply 132, user interface 134, video interface 136, and packaging 138. The video interface may include, for example a USB port, Bluetooth, Wi-Fi, Firewire, SD socket, IRdA port, or other interface to receive images for projection. The video interface may communicate with the video control electronics 106 using a variety of interfaces including Bluetooth, USB, etc., according to various embodiments. According to an embodiment, the system resources include an operating system capable of retrieving images or video from a passive storage device such as a USB drive, SD card or other memory, and projecting images or video individually or in a slide show. This may be useful, for example, for accepting a memory device from a digital camera and projecting recently captured images to friends and family.

FIG. 2 is a perspective view of an integrated optical engine portion 114 of an integrated photonics module 102 according to an embodiment. An optical frame 202 supports three light sources 204, 206, and 208; beam shaping optics (not shown); a beam combiner 210; and a beam scanner 120 in optical alignment with one another to deliver a scanned modulated beam through an output face 212 as shown. The integrated optical engine portion 114 may have outer dimensions of: 11.5 mm high by 23 mm deep by 40 mm wide (less than ½ by 1 by 1-⅝ inches) to allow for easy integration into even size-constrained portable electronic devices. This amounts to just 10.6 cubic centimeters (0.65 cubic inches).

According to some embodiments, the optical frame 202 may be thermally coupled to the light sources 204, 206, and 208. Such thermal coupling may allow the optical frame to act as a heat sink for the light sources. A thermistor, thermocouple, etc. may be thermally coupled to the optical frame 202 to monitor temperature. The light output may be modified, shut down, etc. if it is determined the temperature is out of an operating range.

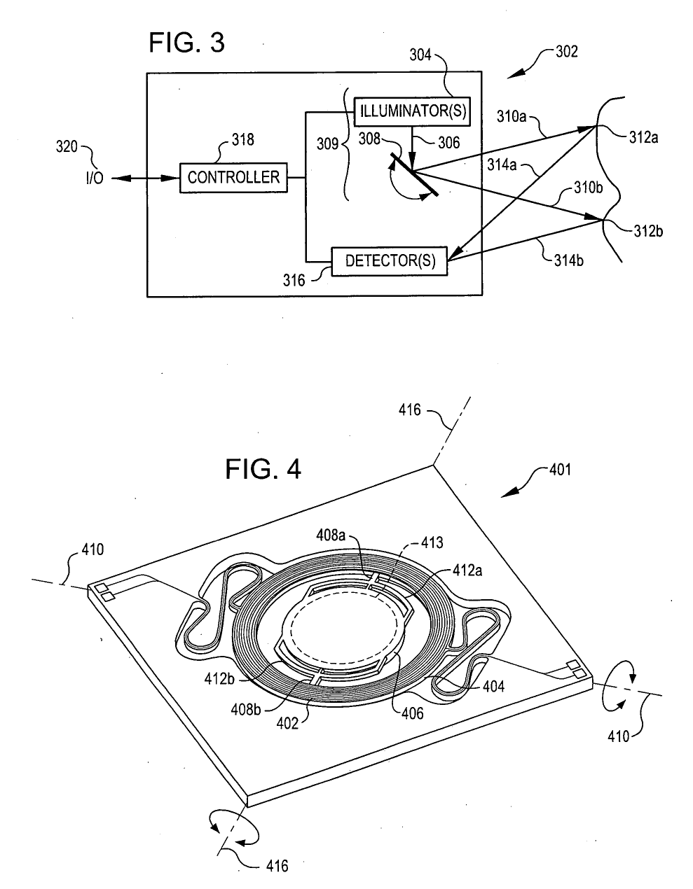

FIG. 3 is a block diagram of a scanned beam imager 302 according to an embodiment. An illuminator 304 creates a first beam of light 306. A scanner 308 deflects the first beam of light across a field-of-view (FOV) to produce a second scanned beam of light 310, shown in two positions 310a and 310b. The scanned beam of light 310 sequentially illuminates spots 312 in the FOV, shown as positions 312a and 312b, corresponding to beam positions 310a and 310b, respectively. While the beam 310 illuminates the spots 312, the illuminating light beam 310 is reflected, absorbed, scattered, refracted, or otherwise affected by the properties of the object or material to produced scattered light energy. A portion of the scattered light energy 314, shown emanating from spot positions 312a and 312b as scattered energy rays 314a and 314b, respectively, travels to one or more detectors 316 that receive the light and produce electrical signals corresponding to the amount of light energy received. The electrical signals drive a controller 318 that builds up a digital image and transmits it for further processing, decoding, archiving, printing, display, or other treatment or use via interface 320.

Light source 304 may-include multiple emitters such as, for instance, light emitting diodes (LEDs), lasers, thermal sources, arc sources, fluorescent sources, gas discharge sources, or other types of illuminators. In some embodiments, illuminator 304 comprises a red laser diode having a wavelength of approximately 635 to 670 nanometers (nm). In another embodiment, illuminator 104 comprises three lasers; a red diode laser, a green diode-pumped solid state (DPSS) laser, and a blue DPSS laser at approximately 635 nm, 532 nm, and 473 nm, respectively. While laser diodes may be directly modulated, DPSS lasers generally require external modulation such as an acousto-optic modulator (AOM) for instance. In the case where an external modulator is used, it is considered part of light source 304. Light source 304 may include, in the case of multiple emitters, beam combining optics to combine some or all of the emitters into a single beam. Light source 104 may also include beam-shaping optics such as one or more collimating lenses and/or apertures. Additionally, while the wavelengths described in the previous embodiments have been in the optically visible range, other wavelengths may be within the scope of the invention.

Light beam 306, while illustrated as a single beam, may comprise a plurality of beams converging on a single scanner 308 or onto separate scanners 308.

A 2D MEMS scanner 208 scans one or more light beams at high speed in a pattern that covers an entire 2D FOV or a selected region of a 2D FOV within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern so as to create a progressive scan pattern. A progressively scanned bi-directional approach with a single beam scanning horizontally at scan frequency of approximately 19 KHz and scanning vertically in sawtooth pattern at 60 Hz can approximate an SVGA resolution. In one such system, the horizontal scan motion is driven electrostatically and the vertical scan motion is driven magnetically. Alternatively, both the horizontal and vertical scan may be driven magnetically or capacitively. Electrostatic driving may include electrostatic plates, comb drives or similar approaches. In various embodiments, both axes may be driven sinusoidally or resonantly.

Several types of detectors may be appropriate, depending upon the application or configuration. For example, in one embodiment, the detector may include a simple PIN photodiode connected to an amplifier and digitizer. In this configuration, beam position information may be retrieved from the scanner or, alternatively, from optical mechanisms, and image resolution is determined by the size and shape of scanning spot 312. In the case of multi-color imaging, the detector 316 may comprise more sophisticated splitting and filtering to separate the scattered light into its component parts prior to detection. As alternatives to PIN photodiodes, avalanche photodiodes (APDs) or photomultiplier tubes (PMTs) may be preferred for certain applications, particularly low light applications.

In various approaches, simple photodetectors such as PIN photodiodes, APDs, and PMTs may be arranged to stare at the entire FOV, stare at a portion of the FOV, collect light retrocollectively, or collect light confocally, depending upon the application. In some embodiments, the photodetector 316 collects light through filters to eliminate much of the ambient light.

The present device may be embodied as monochrome, as full-color, and even as a hyper-spectral. In some embodiments, it may also be desirable to add color channels between the conventional RGB channels used for many color cameras. Herein, the term grayscale and related discussion shall be understood to refer to each of these embodiments as well as other methods or applications within the scope of the invention. In the control apparatus and methods described below, pixel gray levels may comprise a single value in the case of a monochrome system, or may comprise an RGB triad or greater in the case of color or hyperspectral systems. Control may be applied individually to the output power of particular channels (for instance red, green, and blue channels) or may be applied universally to all channels.

In some embodiments, the illuminator may emit a polarized beam of light or a separate polarizer (not shown) may be used to polarize the beam. In such cases, the detector 316 may include a polarizer cross-polarized to the scanning beam 310. Such an arrangement may help to improve image quality by reducing the impact of specular reflections on the image.

FIG. 4 is a perspective view of the chip portion 401 of an exemplary biaxial MEMS scanner, according to an embodiment. The MEMS scanner chip 401 includes a drive coil 402 on a gimbal ring 404 with an inner scan plate 406 being induced to “ring” through mechanical coupling across its torsion arms 408a and 408b. Drive coil 402 rotates the assembly comprising gimbal ring 404 and inner scan plate 406 about axis 410 directly. In this form, the drive signal for the resultant slow scan may be either resonant or may have another arbitrary shape. In some embodiments, the slow scan may be of a modified sawtooth form with progressive movement around the axis alternating with a rapid fly-back to the starting position. When the drive signal also includes a component modulated at the resonant frequency of the inner scan plate 406, the very slight mechanical response of the gimbal 404 gets transmitted across torsion arms 408a and 408b, through suspension elements 412a and 412b, to scan plate 406. Owing to the resonant response of the inner scan plate, the transmitted movement amplified by the system and result in resonant rotation of the inner scan plate about fast scan axis 416. When a mirror 413 is formed on inner scan plate 406, the resultant rotational movements may be used to direct a beam of light across a two-dimensional field of view.

Movement of the gimbal ring 404 around the slow scan axis 110 has been discovered to result in variations in the resonant behavior of the inner scan plate 406 as it rotates around the fast scan axis 416. During a portion of a frame, these variations may- be exhibited as somewhat increased scan velocity, leading to an advance in phase. During another portion of a frame, the increased scan velocity may decrease, resulting in relatively stable fast scan phase. During another portion of a frame, the scan velocity may decrease, leading to a retarding of fast scan phase.

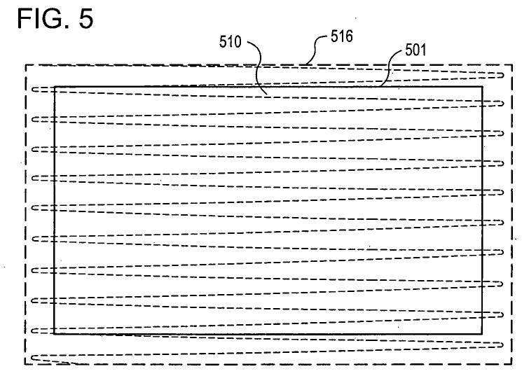

FIG. 5 illustrates a simplified scan path 510 traversing a display area 501 in a field-of-view 516. In the illustrative embodiment, the scan path may be a two-dimensional pattern sequentially scanned by a beam of light. The 2D pattern may be scanned in a periodically repeating manner to provide successive frames of video. According to some embodiments, the frames may be repeated at a video rate such as 60 Hz.

The scan pattern or path 510 is illustrated as a pattern corresponding to a resonant bi-directional horizontal scan superimposed over a smooth vertical ramp. Accordingly, raster pinch may be seen at the lateral extremes of the scan pattern. The display area 501 is illustrated as occupying a portion of the field of view 516 with over-scan regions at each lateral extreme as well as optional over-scan regions at each vertical extreme. Provision for such over-scan regions may be desirable to reduce the degree of raster pinch and hence deviation from parallel horizontal scan lines. Additionally or alternatively, interpolation, correction scanning, etc. may be included to provide a respective virtual or real scan pattern that more nearly approaches straight horizontal scan lines.

The scan pattern 510 provides sequential addressing of the display area 501. According to some embodiments, the scanned beam of light may be modulated synchronously with scanning to display an image such as a video image. According to other embodiments, light scattered from the scan pattern 510 may be collected and detected by a light detector to detect an image traversed by the scan pattern. A sequentially addressed, non-imaging detector may be used to detect the scattered light, with spatial information being provided by the time sequential pattern of the scanned beam.

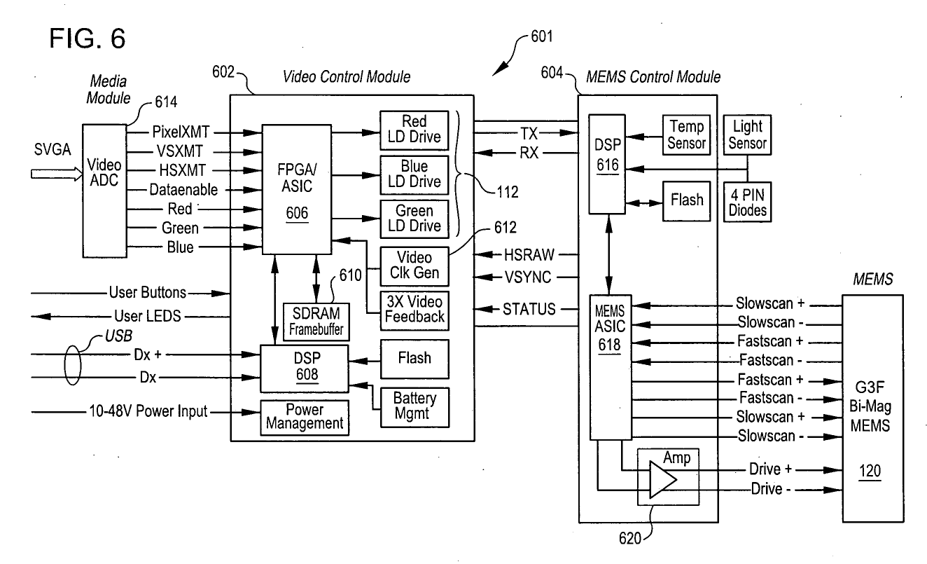

FIG. 6 is a block diagram for a display controller 601 including a video control module 602, a scanner control module 604, and a beam scanner 120 according to an embodiment. The video control module includes a video control application-specific integrated integrated circuit (ASIC) or field-programmable gate array (FPGA) 606, a digital signal processor (DSP) 608, video memory 610 for caching received video data, circuitry 112 for driving light sources synchronously with scanning, and other circuitry.

The video control module 602 may be operable to perform some or all of: receiving a video signal from a system resource, optionally caching the received video data in video memory, converting the signal to a de-gamma signal, converting the de-gamma signal to an equalized color signal, buffering lines, performing interpolation to determine the value of actual pixel positions scanned by the scanned beam as a function of ideal pixel positions in the received video signal, determining luminance values for light sources, performing light source compensation and calibration, and passing compensated luminance values to light source drive circuitry synchronously with timing signals received from a video clock, the video clock being derived from horizontal (HSRAW) and vertical (VSYNC) synchronization pulses provided by the MEMS control module 604. As may be seen, the video control module 602 may include a video clock generator 612 operable to generate a compensated video clock from the received HSRAW signal as described below.

Optionally, the video control module 602 may include or receive video data from a media module 614 operable to convert a received video format into a preferred video format. According to one embodiment, the media module 614 may be operable convert a received analog video signal into a digital video signal. According to other embodiments, the media module may be omitted or may be integrated as a system resource.

The media module 614 may provide red, green, and blue (RGB) pixel values for pixels to be displayed. The RGB pixel values may, for example, be sequentially clocked into the video controller synchronously with a PixelXMT clock used to sequence the pixels. The video control module 602 may include one or more frame buffers 610 as illustrated, or alternatively may rely on line buffers. The media module 614, which may be local or remote, may pre-format the pixel data, for example by reversing every other scan line to account for bidirectional beam scanning, or alternatively, the video control module may provide such formatting.

As may be appreciated, synchronization signals such as pixel transmit (PixelXMT), vertical synchronization transmit (VSXMT), and horizontal synchronization transmit (HSXMT) may be generated by the media module asynchronously with the physical movement of the MEMS scanner. The video control module 602 may thus be operable to resolve timing differences between an incoming video signal and displayed pixels.

The MEMS control module 604 may include a microprocessor or DSP 616 configured to control the operation of a MEMS ASIC 618. The MEMS ASIC is operable to provide drive signals to the MEMS scanner 120 via one or more DAC(s) and amplifier(s) 620.

Aspects of several embodiments of operability of the display controller 601 are disclosed in U.S. patent application Ser. No. 11/316,326, entitled CIRCUIT FOR DETECTING A CLOCK ERROR IN A SWEPT-BEAM SYSTEM AND RELATED SYSTEMS AND METHODS; U.S. patent application Ser. No. 11/316,683, entitled CIRCUIT FOR DETECTING A CLOCK ERROR IN A SCANNED IMAGE SYSTEM AND RELATED CIRCUITS, SYSTEMS, AND METHODS; U.S. patent application Ser. No. 10/630,062, entitled METHOD AND APPARATUS FOR ILLUMINATING A FIELD-OF-VIEW AND CAPTURING AN IMAGE; U.S. patent application Ser. No. 10/441,916 entitled APPARATUS AND METHOD FOR BI-DIRECTIONALLY SWEEPING AN IMAGE BEAM IN THE VERTICAL DIMENSION AND RELATED APPARATI AND METHODS; U.S. patent application Ser. No. 10/118,861 entitled ELECTRONICALLY SCANNED BEAM DISPLAY; U.S. patent application Ser. No. 10/933,033 entitled APPARATUSES AND METHODS FOR UTILIZING NON-IDEAL LIGHT SOURCES; U.S. Pat. No. 6,661,393 entitled SCANNED DISPLAY WITH VARIATION COMPENSATION; and U.S. Pat. No. 6,445,362 also entitled SCANNED DISPLAY WITH VARIATION COMPENSATION; all incorporated by reference herein.

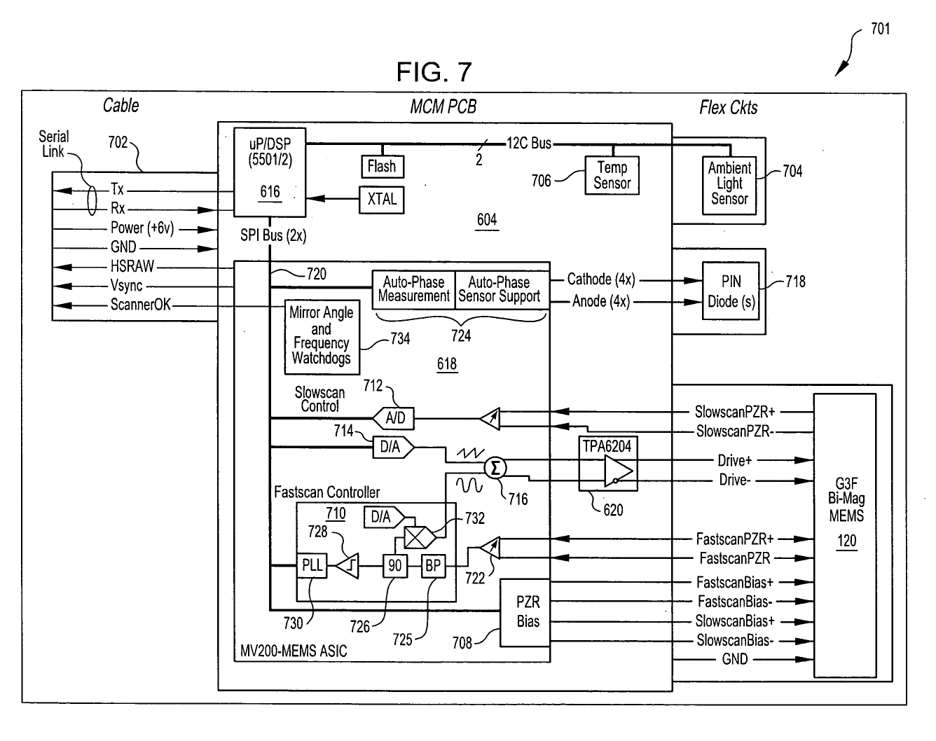

FIG. 7 is an embodiment 701 showing a more detailed block diagram of the MEMS control module 604 and its relationship with the MEMS scanner 120 of FIG. 6. The scanner controller 122 includes a scanner control ASIC 618, a digital signal processor (DSP) 616 that is operable as a co-processor, supporting circuitry including power supply circuitry and memory, and flex circuit interconnects on a printed circuit board. It may be noted that the embodiment of FIG. 7 comprises a somewhat reduced level of integration compared to the scanner controller 122 of FIG. 1, in which a larger portion of control functionality is integrated into a scanner control ASIC. According to various embodiments, the general theory of operation may be similar.

The scanner control module 604 is operable to drive a bi-axial MEMS scanner 120 while providing appropriate timing information to video controller electronics across the controller interconnection 702. The scanner control module 604 may additionally be operable to monitor ambient light levels and process auto-phase calibration pulses and optionally relay these measurements to the video controller electronics.

One scanner embodiment includes a MEMS scanner with magnetic drive on two axes and PZR sensors for both axes.

According to some embodiments, the scanner controller 604 may be physically mounted near an optical engine portion of an integrated photonics module (not shown) or other scanned beam image capture or display apparatus. According to some embodiments such as a head-mounted display, the scanner control module 604 may reside at a distal location near the scanner and may be physically separated from light sources and at least a portion of beam combiner and beam shaping optics, the light source and beam shaping optics being configured to provide light to the mirror of the MEMS scanner 120 at a distal location from a proximal location through an optical fiber to the distal location. Similarly, the video controller electronics (not shown) may be mounted proximally near the light source and beam shaping optics and communicate with the distally mounted scanner control module 604 via an electrical, radio, or optical interface 702. In such an embodiment, it may be appropriate to mount the proximal portions of the integrated photonics module in a compact package that may be supported on a belt of the user and mount the distal portions of the system in a head-mounted package.

According to an embodiment, the DSP 616 may provide slow scan Fast Fourier Transformation (FFT) processing to provide tuning and active damping of the slow scan according to methods disclosed in U.S. patent application Ser. No. 11/266,584, entitled CIRCUIT FOR DRIVING A PLANT AND RELATED SYSTEM AND METHODS, incorporated herein by reference. Additionally, the DSP 616 may provide functionality including one or more of data communications with the video controller electronics; provide an interface for inputting calibration data for the MEMS scanner; pass parameters related to MEMS operation, auto-phase results, ambient brightness received from an ambient light sensor 704, temperature received from temperature sensor 706, etc. during normal operation to the video controller electronics; an interface for field upgrade of firmware and software; task scheduling to ensure proper timing of critical operations; initialization and adjustment of fast scan oscillator registers; and open-loop temperature compensation of PZR sensors.

According to an embodiment, the scanner drive ASIC 618 may be a mixed-signal (analog and digital) device operable to provide MEMS control and provide automatic phase (auto-phase) correlation. The scanner drive ASIC 618 is operable to drive and control a bi-axial MEMS scanner 120. The bi-axial MEMS scanner 120 may be of a type that is magnetically actuated on both axes with piezo-resistive (PZR) feedback sensors and may include a scanner chip as illustrated in FIG. 4.

According to embodiments, the scanner drive ASIC 618 may include a variety of analog and digital functions. The ASIC 618 may provide user programmable current bias to the PZR feedback sensors with a PZR bias circuit 708. The ASIC 618 may provide a closed-loop oscillator circuit 710 operable to self-resonate the fast scan axis at a programmable amplitude, wherein AGC parameters may be adjustable allowing soft-start and tuning control options. The ASIC 618 may provide a phase-locked loop (PLL) to create a slow scan sample clock (50 to 200 kHz) that is synchronous with the fast scan resonant frequency, wherein the multiplication factor may be programmable. The ASIC 618 may provide a slow scan analog to digital converter (ADC) 712, wherein the slow scan input signal from the PZR amplifier is converted to a digital signal for the DSP processor 616, and wherein the ADC resolution may be 12 to 16 bits with a sample rate of 50 to 200 kHz. The ASIC 618 may provide a slow scan digital to analog converter (DAC) 714, wherein the digital input signal for the slow scan waveform is converted to an analog voltage and summed with the fast scan drive signal in a summing circuit 716. The ASIC 618 may provide a mirror status signal indicating the mirror angle is within the acceptable range. The ASIC 618 may provide auto phase sensor interface circuitry, wherein the circuitry operates with external photo detector(s) 718 to condition~the signals for the auto phase function and measures the result. The ASIC 618 may also provide an SPI serial digital interface 720 to communicate with the video controller electronics and allow read/write access to the internal registers for initialization and monitoring.

The fast scan oscillator block 710 uses the PZR feedback signal to create a closed loop oscillator circuit. The oscillation frequency is determined by the resonant frequency of the scanner's fast scan axis. The amplitude of the oscillation is controlled by an AGC circuit that has a programmable set point. The output from this loop is the HSRAW which is a square wave at the FS resonant frequency that provides a master synchronization signal to drive other system components. The resonant frequency can vary from about 5 kHz to 40 kHz. As will be appreciated, the HSRAW signal may also vary according to vertical scan position.

The slow scan position signal is received from the slow scan PZRs on the MEMS scanner 120, then amplified, filtered, and converted to digital in the slow scan ADC 712. This digital signal is sent to the DSP 616 for analysis. The DSP sends back a digital command signal that is converted to analog in the slow scan DAC 714. The analog slow scan drive signal is summed with the fast scan output in the summing circuitry 716, and the sum is sent to the external power amplifier 620, which amplifies the summed analog signal to provide drive power to the scanner 120.

The automatic phase circuitry 724 works with one or more external optical detectors 718. The scanned beam 125 (not shown) periodically crosses over the detector(s) 718. The automatic phase circuitry 724 produces a pulse in response to the laser beam crossing, and the pulse length is the information that is transmitted to the DSP 616.

The fast scan oscillator 710 is an analog ‘self-resonant’ circuit that takes real-time position information from the MEMS PZR sensors, applies appropriate amplitude gain and phase delay, and drives the MEMS fast scan on resonance based on the mirror's feedback signal. Blocks with registers may be adjustable via the SPI processor interface to provide MEMS characterization to accommodate device-to-device, lot-to-lot, and/or design-to-design tolerances.

The fast scan motion of the mirror is sensed with PZR strain sensors incorporated in the die flexures on the MEMS scanner 120. The PZR sensors are provided an adjustable DC bias current by the PZR bias circuitry 708. The bias current may be programmed with a software controlled value or with an external resistor. The PZR feedback differential sense signals are amplified in a low-noise differential pre-amplifier 722 with an adjustable gain. The gain of the differential pre-amplifier 722 may be software controlled or may be set with an external resistor to provide calibrated signal level (in peak-to-peak voltage) for a given mirror angular deflection. The pre-amplifier 722 output is filtered in the band pass filter 725 that limits the noise bandwidth. The band pass filter 725 may include a high pass filter followed by a low pass filter. The output signal of the band pass filter 725 may be used to drive the scanner control system. At resonance, there is a 90 degree phase shift between the drive signal and the scanner motion. To sustain closed loop oscillation, an extra 90 degrees of phase shift is introduced into the loop with phase shifter 726. The output of the phase shifter 726 is converted to a digital square wave by a comparator 728 to create a digital fast scan synchronization signal, HSRAW. The fast scan synchronization signal may transmitted through a phase-locked loop output 730 to the DSP 616 and used as the primary time base for the slow scan drive as well as an input for determining a video clock for clocking pixels in the video controller electronics (not shown).

An automatic gain control (AGC) circuit may be used to maintain the oscillation amplitude at a very precise value. The loop may include an amplitude detector, a variable gain amplifier, and an AGC controller. The amplitude detector produces a DC voltage proportional to the amplitude of output of the band pass filter 725. This voltage is compared to the set point in the AGC controller, which implements a proportional-integral-differential (PID) control algorithm. The output of the PID controller is used as the control voltage input of a variable gain amplifier 732.

Mirror angle and frequency watchdog circuits 734 monitor the output of the amplitude detector. If the amplitude exceeds a programmable set point, then the protection circuit issues a shutdown command that immediately disables the drive signal. A secondary safety circuit monitors the amplitude of the drive signal, and prevents it from exceeding a programmable value.

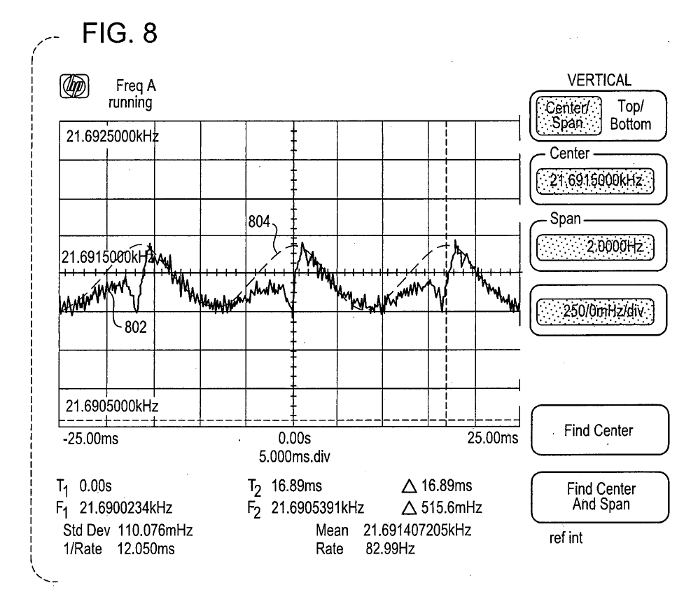

Referring now to FIG. 8, a systematic variation was observed in horizontal or fast scan resonant frequency as a function of vertical or slow scan position. As described above, a MEMS scanner may operate as a two-dimensional deflection mirror. The horizontal scan axis is normally operated near its resonant frequency, f₀. This resonant frequency varies slightly as a function of vertical motion. FIG. 8 shows a plot 802 of fast scan frequency as a function of time. The vertical axis is frequency and the horizontal axis is time. The data was captured with a modulation domain analyzer, which shows the way that frequency varies with time. In other words, the MEMS horizontal frequency is frequency modulated and the modulation domain analyzer shows the effective modulation input as though it were demodulated and displayed on a scope.

The vertical scanner may be operated near its resonant frequency or may be operated in a ramp waveform with a fly back between frames. Since the frame rate of the illustrative scanner is 60 Hz, if the resonant frequency f₀ of the horizontal scanner is affected by the vertical scanner, resonant motion of the horizontal scanner may be expected to exhibit a 60 Hz dependency. Indeed, as shown by the dashed best-fit sine wave 804, the horizontal resonant frequency was found to have a 60 Hz variation. Another notable feature of the curve 802 is the large discontinuity seen in every period. This is related to the fly back portion of the vertical drive. Since the discontinuity occurs during the inter-frame blanking period when no pixels are projected or gathered, this discontinuity is less of an issue with respect to pixel placement accuracy than is the “sinusoidal” variation of resonant motion between the discontinuities.

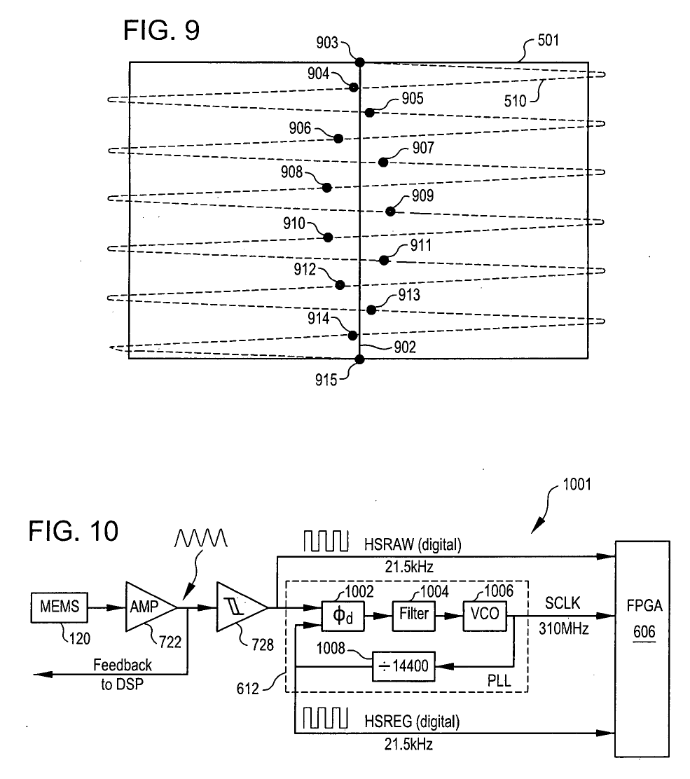

If pixels are clocked at a constant frequency, the variation in resonant frequency of the horizontal scanner may cause image quality degradation such as is illustrated in FIG. 9. FIG. 9 is an illustration of a bidirectional scan path 510 across a field-of-view 501. As with the diagram of FIG. 5, the horizontal scanning component operates to deflect a scanning beam back and forth in a horizontal direction at a relatively high frequency while the vertical scanning component smoothly deflects the beam from top to bottom. The combined effect produces the beam scan path illustrated by the dashed line 510 (simplified here to increase line separation and show more clearly the effects described.

In the illustrative example of FIG. 9, a vertical line 902 is to be displayed (or captured). In the upper part of the frame 501, the horizontal component of the MEMS scanner has a slightly higher than nominal resonant frequency, and hence the MEMS scanner runs slightly fast relative to a constant clock. Pixels clocked according to a constant clock thus increase in phase error, being placed or captured progressively further to the left of the intended vertical line 902 during right-to-left scans (see pixels 904 and 906), and progressively further to the right of the intended vertical line 902 during left-to-right scans (see pixels 903, 905 and 907). In the vertically central portion of the field-of-view 501, the MEMS scanner runs substantially at its nominal resonant frequency, halting the progressive deviation of pixels from the intended vertical line. However, because the phase of the MEMS scanner was earlier advanced relative to a constant clock, the pixels 908, 910 produced in right-to-left scans remain displaced to the left of the vertical line 902 and pixels 909, 911 produced in left-to-right scans remain displaced to the right of the vertical line 902. During the last portion of the frame, corresponding to the lower portion of the field-of-view 501, the MEMS scanner runs progressively slower than the constant clock. Pixels 912, 914 produced during right-to-left scans move progressively rightward toward the vertical line 902, and pixels 913, 915 produced during left-to-right scans move progressively leftward toward the vertical line 902. This phenomenon has been described colloquially as a “split line error” for obvious reasons.

According to an embodiment, the split line error illustrated in FIG. 9, which arises from the systematic variation in horizontal resonant scan frequency illustrated in FIG. 8, may be substantially eliminated by allowing the reference clock used to clock out pixels to vary in concert with the variation in horizontal scan frequency. This approach may maintain a substantially constant phase relationship between the MEMS scanner and the video output.

FIG. 10 is a block diagram of a circuit 1001 including a video clock synthesizer 612 according to an embodiment wherein the video clock output (SCLK) used to clock pixels is allowed to vary along with the systematic variation in horizontal scan position. The video clock synthesizer includes a phase detector 1002, a filter 1004, a voltage controlled oscillator (VCO) 1006, and a clock frequency divider (divide-by-N) 1008 in a feedback loop to produce a compensated output clock SCLK.

The phase detector 1002 accepts a horizontal synchronization pulse HSRAW as its reference input. The PLL generates a compensated output clock (SCLK) that is divided down by an integer in a divide-by-N circuit 1008 to create a feedback clock HSREG for the phase detector. The phase detector compares the reference and feedback signals. Any phase difference is converted into current pulses that are integrated and converted to a voltage by the filter 1004. Any shift in the reference frequency is accompanied by a corresponding shift in voltage at the filter output.

When the MEMS horizontal signal HSRAW is applied as the reference input to the phase detector 1002, the filter output may be a demodulated signal similar to the waveform 802 of FIG. 8. Depending on the filter bandwidth, the signal may be smoothed compared to the waveform 802. The voltage output from the filter 1004 is used to directly drive the VCO 1006. A feedback loop is created by dividing down the VCO output by a frequency divider 1008 and feeding the divided clock back to the phase detector as described above.

Systems may contain jitter arising from various sources such as the output of PZRs or other MEMS position sensors. Any jitter present at the input of the phase detector 1002 may also be demodulated and appear as noise at the filter output. Noise at the filter output is undesirable because it is converted to jitter by the VCO. The loop filter defines how quickly the PLL responds to a change in input phase. Accordingly, the filter 1004 may be selected to have a low pass bandwidth that is high enough to substantially reflect real changes in phase differences between HSRAW and HSREG, but low enough to reject jitter.

One solution to the loop filter design involves identifying the frequency components of the modulating signal, determining the acceptable pixel placement error and the corresponding phase shift, and selecting a filter roll-off frequency that will limit the phase shift accordingly.

In the case of the MEMS data 802 shown in FIG. 8, there are some repeated high frequency components exhibited as vertical transients in the waveform. However, these components occur during vertical synchronization, that is, during the vertical “flyback” time of the MEMS. During the flyback time, video is normally blanked so pixel placement error may not be an issue. If this region of the data is ignored, the frequency content of the remaining data may be estimated. As described above, the frequency content was estimated to be about 60 Hz, as shown by the dashed line 804.

One approximation is that the phase error of a low-pass filter approaches zero at 10× the cut-off frequency. Therefore, a loop filter was initially designed for 600 Hz. The filter was implemented and the system was tested. To evaluate performance, maximum pixel placement error was selected to be ±1 nS. At SVGA resolution, this equates to less than 1/10th of a pixel.

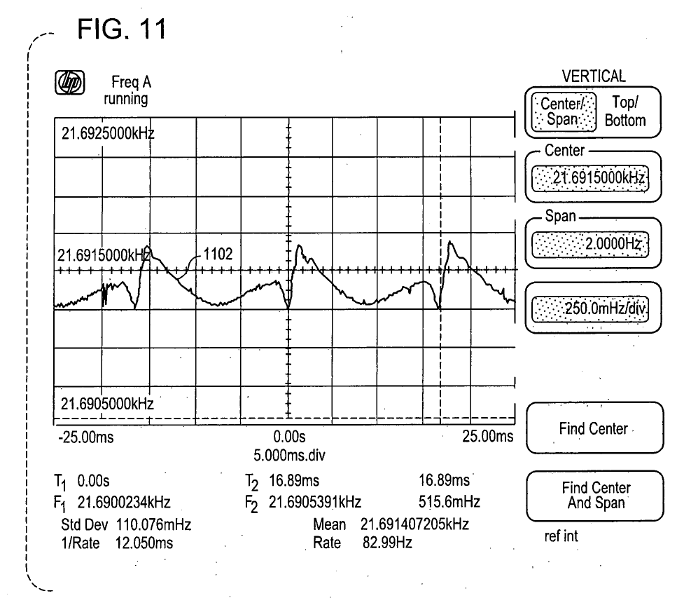

FIG. 11 illustrates a data plot 1102 of the oscillation frequency output of the VCO of FIG. 10 using a filter 1004 low pass frequency of about 600 Hz. In comparison with the data plot 802 of FIG. 8, it may be seen that the very high frequency jitter is smoothed but the VCO is still able to track the systematic variations in scanner resonant frequency.

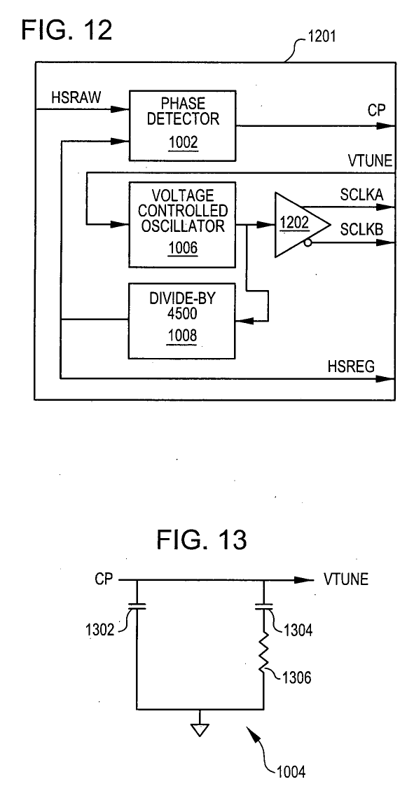

According to an embodiment, the system described above may be implemented using a phase-locked loop integrated circuit and an external filter loop. FIG. 12 illustrates a typical phase-locked loop integrated circuit 1201 comprising a phase detector 1002, a voltage controlled oscillator (VCO) 1006, a clock divider 1008, and a differential driver 1202 for outputting the compensated video clock. One exemplary device is manufactured by ANALOG DEVICES M, designated as an INTEGRATED INTEGER-N SYNTHESIZER AND VCO. An alternative integrated circuit is manufactured by IDT® and designated GENERAL PURPOSE IC FREQUENCY SYNTHESIZER, part number ICS673.

As may be seen, the phase detector 1002 receives HSRAW on an external pin, and receives HSREG on an internal terminal from the clock divider 1008. The phase detector 1002 receives HSRAW and HSREG and outputs current proportional to the phase difference between HSRAW and HSREG to an external pin designated CP. Current flows from the phase detector 1002 only when the rising edges of HSRAW and HSREG do not occur at the same time. When HSRAW rises first, 683 μA flows from the phase detector 1002 to CP until HSREG rises. When HSREG rises first, 683 μA flows from CP to the phase detector 1002 until HSRAW rises. Thus, charge is output to CP when HSRAW is advanced in phase compared to HSREG, a condition that may be encountered during portions of the frame when the horizontal resonance frequency of the MEMS scanner is increased. Conversely, charge is drained from CP when HSREG is advanced in phase compared to HSRAW, a condition that may be encountered during portions of the frame when the horizontal resonance frequency of the MEMS scanner is decreased.

Referring to FIG. 13, the variable current level on CP is received by an external filter circuit 1004, which is operative to provide a filtered output voltage VTUNE proportional to a filtered value of the charge received on CP. When current flows to CP (because HSRAW leads HSREG in phase), voltage on the positive terminals of the capacitors 1302 and 1304 increases. When current flows from CP (because HSREG leads HSRAW in phase), voltage on the positive terminals of the capacitors 1302 and 1304 decreases. Since the voltage on the positive plates of the capacitors 1302 and 1304 corresponds to VTUNE, the circuit 1004 is operative to produce VTUNE. When HSRAW is ahead of HSREG in phase, voltage VTUNE increases, causing the VCO to increase its oscillation frequency, tending to advance the phase of HSREG to “catch-up” to HSRAW. When HSRAW is behind HSREG in phase, voltage VTUNE decreases, causing the VCO to decrease its oscillation frequency, causing the phase of HSREG to be retarded, thus driving HSREG to approach the same phase as HSRAW. Thus, frequency changes in the horizontal scanner arising from variations in resonance frequency are tracked by the compensated video clock SCLK. The compensated video clock SCLK may then be used to output or receive pixels at their intended positions, reducing split line error.

The voltage on the positive plates of the capacitors 1302 and 1304 increases and decreases proportionally the phase difference between HSRAW and HSREG. The rate of voltage increase and decrease is related to the time constant of the RC circuit formed by the capacitors 1302, 1304 and the resistor 1306. Faster voltage response may generally be tuned into VTUNE by decreasing the respective capacitance and resistance values of the capacitors 1302, 1304, and resistor 1306; and slower voltage response may be tuned by increasing the values. Thus, the filter 1004 forms a charge pump whose pass band may be easily tuned. According to one embodiment, a bandwidth of 683 Hz was found to provide excellent performance in a 60 Hz frame rate system showing the fast scan resonant frequency variations shown in FIG. 8. This was achieved by selecting component values of 2.2 nF for the capacitor 1302, 15 nF for the capacitor 1304, and 34 KΩ for the resistor 1306, with a CP current of 313 μA. The N-Divider value was 4500 and the phase margin was 48.6°.

According to one embodiment, the bandwidth may be selected corresponding to the scan frequency, scan angle, sensor noise characteristics, horizontal scan—vertical scan crosstalk, actuator type and characteristics, and other attributes of the beam scanner. According to an example, a wide angle beam scanner may tend to have relatively greater crosstalk between the horizontal and vertical scanner than a narrower angle beam scanner, thus making it desirable for the voltage VTUNE to accurately track higher rate changes in phase difference. Such capability may be selected, for example, by tuning the filter 904 to a higher frequency pass band.

According to another embodiment, the capacitance and/or resistance values of the components of the filter 904, and hence the bandwidth of the filter may be actively controlled, for example to optimize pixel placement in accommodation to changes in driven scan angle, changes in sensor jitter characteristics, and/or other application parameters.

Referring again to FIG. 12, VTUNE is received on an external pin of the PLL integrated circuit 1201. The VCO 1006 receives VTUNE and responsively oscillates at a frequency proportional to the voltage of VTUNE. An internal differential driver 1202 receives the oscillation signal and outputs the signal SCLK as a differential pair (SCLKA and SCLKB) on external pins. The output of the VCO 1006 is also received by an internal clock divider 1008. The divide value of the clock divider 1008 may be set equal to the number of clock cycles per line output by the VCO on SCLK, thus producing the feedback signal HSREG.

According to an embodiment, HSRAW is produced from a piezo-resistive (PZR) sensor embedded in the torsion arms of the MEMS scanner, configured as a bridge with a cycle being produced at every zero-crossing. Since zero-crossings correspond to the scanner passing the center of its scan range, one zero-crossing is produced each time the scanner crosses from left-to-right and a second zero-crossing is produced each time the scanner crosses from right-to-left, thus producing the signal HSRAW at a nominal frequency equal to twice the horizontal scan line frequency. According to other embodiments, other types of position sensors may be used. For example an optical sensor, magnetic sensor, capacitive sensor, or other configuration may produce a signal HSRAW equal to the same or a different frequency relative to the horizontal scan frequency. A phase shifter (not shown) may provide fixed phase offset or matching between the divided VCO signal HSREG to the incoming signal HSRAW. According to some embodiments, a greater or lesser number of video clock cycles on SCLK per line may be desirable. The divide-by value of the clock divider 1008 may be selected appropriately.

According to one embodiment, HSRAW is produced at twice the horizontal scan frequency, the video clock SCLK is set at a static value of 9000 cycles per horizontal scan period (thus nominally producing 4500 cycles in each direction) and the clock divider is set to divide by 4500. According to other embodiments, the video clock SCLK may be dynamically selected and the clock divider may be provided with a corresponding actively controlled divide-by value corresponding to the frequency of the video clock.

According to some embodiments, the feedback from the sensor and hence the signal on HSRAW may be intermittent. In such cases, bandwidth of the filter 1004 may be set relatively lower to accommodate intermittent sensor signals. Additionally or alternatively, the VCO 1006 may be provided with a conditionally latched VTUNE voltage to maintain a video clock SCLK in the absence of a valid voltage value from the filter 1004.

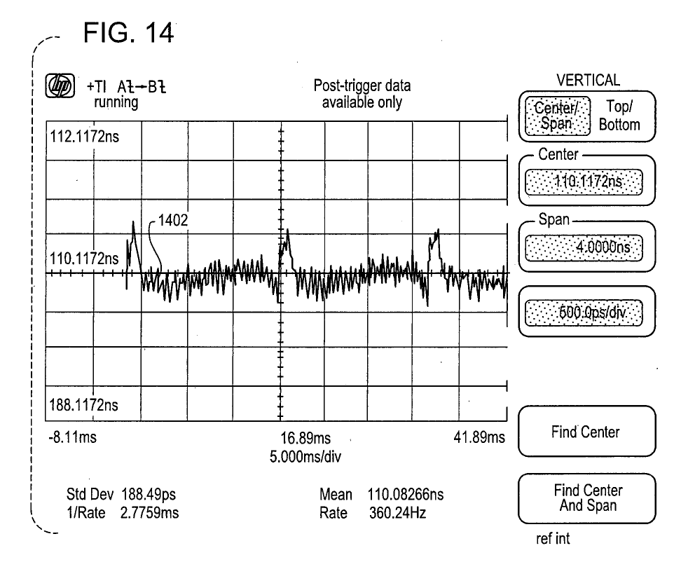

FIG. 14 shows a plot 1402 of the difference between HSRAW and HSREG as a function of time delivered by a system implementing a compensated video clock SCLK according to approaches described above. The vertical axis is the time delay between the rising edge of HSRAW and the falling edge of HSREG and the horizontal axis is time. Capturing data in this way guarantees that the delay is always positive and thus the plot can show both positive HSRAW-HSREG and negative HSRAW-HSREG rising edge phase variations.

While the fly back, or inter-frame blanking intervals still exhibit some relatively large variations, even these variations are much reduced compared to the plot shown in FIG. 8. For comparison, the entire vertical span of data in FIG. 14 is 4 nanoseconds. FIG. 12, on the other hand, has a span of 2 Hz, which equates to 33 milliseconds! Thus, the approaches described above result in a 10,000-fold decrease in phase error. Whereas systems implemented before the approaches taught herein were forced to use complex remapping of pixels to correct for phase error, systems constructed according to methods herein may be constructed either without such complex remapping, with simplified remapping, a may accommodate MEMS scanners exhibiting more extreme systematic variations in scan frequency, may allow display or capture of accurately place pixels nearer the fly back portions of the frame, etc.

As may be seen in FIG. 14, the loop filter maintains a reasonably constant time relationship during the active video portion of the frame period. In this case, the time difference is less than 500 pS during active video. The result of this loop filter is pixel placement accuracy of about 500 pS, which equates to about 1/20th of a pixel. In addition, the loop filter works to suppress system jitter above frequencies of 600 Hz. This filter is a good compromise between the desire to track frequency modulation of the input and the desire to suppress random system jitter.

Referring again to FIG. 14, it may be noted that phase difference between HSRAW and HSREG may include a shape other than nominally flat. For example the waveform 1402, in the central portion of the cycle (between screen blanking or fly back) exhibits a slight left-to-right upward slope, corresponding to a slight increase in phase difference between HSRAW and HSREG as the vertical scanner moves from top-to-bottom of the frame. This may be understood by realizing that the fitted sine waveform 804, shown superimposed over non-compensated waveform 802 in FIG. 8, is not a completely accurate representation of the cross-talk between the vertical and the horizontal scanner. Indeed, according to an embodiment, high frequency waveform components are superimposed to form the vertical drive ramp, and certain additional components are superimposed to perturb the drive ramp further to compensate for resonant behavior in the vertical scanner. For example the notch in the waveform exhibited just after the fly back, may correspond to the application of superimposed perturbation components used to stabilize the vertical ramp. While the waveform 1402 of FIG. 14 shows such a slight incline that pixel placement accuracy remains very tight, other systems, other scan angles, etc. may exhibit compensated waveforms that result in larger pixel placement inaccuracies.

In such systems, a variable clock offset may be applied to SCLK. For example, a clock delay applied in incremental fractions of a clock cycle as the vertical scan progresses top-to-bottom may be used to correspondingly retard pixel placement from the top to bottom of the frame. According to the example, this may offset the slope of HSRAW-HSREG and maintain more nearly-perfect or improved “split-line” performance.

The preceding overview, brief description of the drawings, and detailed description describe exemplary embodiments according to the present invention in a manner intended to foster ease of understanding by the reader. Other structures, methods, and equivalents may be within the scope of the invention. For example, methods and physical embodiments may be combined or used singly.

While the terms “light” and “light beam” are used, it should be recognized that “light” corresponds to a range of electromagnetic energies that extends beyond wavelengths that may be typically detected by human vision. Except where noted, “light” should be read to encompass a range of wavelengths broader than the visible spectrum.

As such, the scope of the invention described herein shall be limited only by the claims.

What is claimed is:

1. A beam scanning system comprising:
a beam scanner operable to emit a biaxially scanned beam of light in a periodic pattern characterized by a frame rate, the periodic pattern including a resonant fast scan axis and a slow scan axis; and
a controller coupled to the beam scanner including a PLL circuit configured to track systematic variations in fast scan phase vs. slow scan phase of the beam scanner.

2. The beam scanning system of claim 1 wherein the beam scanner includes:
at least one light source operable to produce a beam of light;
a MEMS scanner aligned to receive the beam of light and operable to scan the beam by rotating about the two axes.

3. The beam scanning system of claim 2 wherein the controller is further operable to modulate the at least one light source synchronously with the systematic variations in fast scan phase.

4. The beam scanning system of claim 3 wherein the controller is further operable to correct for phase lag between the systematic variations in fast scan phase tracked by the PLL and actual systematic variations in fast scan phase of the MEMS scanner.

5. The beam scanning system of claim 1 wherein the PLL circuit is operable to track systematic variations in the fast scan phase at a frequency of between about four times and one-hundred times the frame rate.

6. The beam scanning system of claim 5 wherein the PLL circuit is operable to track systematic variations in fast scan phase at a frequency of between about six times and twenty times the frame rate.

7. The beam scanning system of claim 6 wherein the PLL circuit is operable to track systematic variations in fast scan phase at a frequency about ten times the frame rate.

8. The beam scanning system of claim 1 wherein the beam scanner includes a MEMS scanner characterized by systematic variations in fast scan phase angle as a function of slow scan angle.

9. The beam scanning system of claim 1 wherein the periodic pattern includes a fast scan that is bidirectional.

10. The beam scanning system of claim 9 wherein the controller is further operable to modulate the beam of light in pixels corresponding to a received video signal and maintain pixel placement accuracy of within about one pixel.

11. The beam scanning system of claim 10 wherein the controller is further operable to maintain pixel placement accuracy of within about one-half pixel.

12. A method for controlling a scanned beam display, comprising:
receiving a position signal from a resonant beam scanner;
detecting variations in frequency in the position signal;
filtering the detected variations in frequency at a bandwidth configured to reject jitter; and
generating a video clock having a frequency that substantially varies synchronously with the variations in frequency of the position signal.

13. The method for controlling a scanned beam display of claim 12 wherein detecting variations in frequency comprises detecting variations in phase.

14. The method for controlling a: scanned beam display of claim 13 wherein detecting variations in phase comprises comparing the phase of the position signal against the phase of a phase-locked-loop signal.

15. The method for controlling a scanned beam display of claim 12 wherein receiving a position signal from a resonant beam scanner includes receiving a signal from a position detector coupled to a biaxial MEMS beam scanner.

16. The method for controlling a scanned beam display of claim 12 wherein the resonant beam scanner comprises a biaxial MEMS scanner, position signal comprises a signal corresponding to a resonant scan axis, and the variations in frequency in the position signal correspond to cross-talk from a second scanning axis.

17. The method for controlling a scanned beam display of claim 12 wherein the filter comprises a low pass filter having a bandwidth of about ten times the bandwidth of the variations in frequency.

18. A scanned beam display comprising:
a biaxial MEMS scanner operable to scan a beam of light at a first resonant scan frequency in a first resonant scan axis and at a second frequency in a second scan axis;
a position detector operable to detect phase variations in the first resonant scan axis;
a video clock generator functionally coupled to the position detector and operable to generate a variable video clock at a frequency higher than the resonant scan frequency and phase varying in correspondence to the detected phase variations; and
a beam modulator functionally coupled to the video clock generator and operable to modulate a beam of light incident on the biaxial MEMS scanner responsive to the variable video clock.

19. The scanned beam display of claim 18 wherein the beam modulator is modulated at a frequency lower than the video clock and higher than the resonant scan frequency.

20. The scanned beam display of claim 18 wherein the bandwidth of the video clock generator is high enough to respond to the phase variations and low enough to reject jitter in the output of the position detector.
